(19) United States
(12) Patent Application Publication
(10) Pub. No.: US 2007/0195981 A1
(43) Pub. Date: Aug. 23, 2007

(54) Behind-the-ear hearing aid with integrally-molded instrument case

(76) Inventor: Anthony D. Le, Huntersville, NC (US)

Correspondence Address: Schwartz Law Firm, P.C.;SouthPark Towers, Suite 530, 6100 Fairview Road, Charlotte, NC, 28210, US

(21) Appl. No.: 11/360,069

(22) Filed: Feb. 23, 2006

(51) Int. Cl. H04R 25/00

(52) U.S. Cl. 381/330

(57) ABSTRACT

A behind-the-ear hearing aid including an arcuate, integrally-molded instrument case adapted for residing behind an ear of a wearer. The instrument case defines a substantially seamless electronics compartment containing a microphone and a loudspeaker operatively connected to the microphone. An amplifier serves to boost a sound signal transmitted from the microphone through the loudspeaker to the ear of the wearer.

### TECHNICAL FIELD AND BACKGROUND OF THE INVENTION

This invention relates generally to hearing aids, and more specifically, to an open fit behind-the-ear (BTE) hearing aid with a substantially seamless, integrally-molded instrument case. The instrument case is designed to prevent entry of moisture, dust, and other foreign matter into the interior compartment which houses highly sensitive hardware and components essential to proper operation of the hearing aid.

Unfortunately, today 1 in 10 Americans (over 30 million people) experience some degree of hearing loss. Hearing loss is the third leading chronic health condition among Americans, after arthritis and high blood pressure. Additionally, the problem of hearing loss is “growing younger.” 15% of recent college graduates have as much or more hearing loss than their parents. And over two million Americans with hearing loss are under the age of 18.

In many cases, hearing aids offer an effective and practical solution for those dealing with hearing loss. While not all hearing aids work the same way, the basic principles are essentially the same. They all have a built-in microphone that picks up sound which is then processed electronically, either by analogue circuits or digitally. The resulting signals are then passed to a receiver, or earphone, in the hearing aid where they are converted back into sounds to be heard by the wearer.

Digital hearing aids represent the most advanced presently available technology—referred to in the industry as “digital signal processing” (DSP). These such instruments actually contain a computer chip that is programmed by a computer. This offers the best way currently available to match a particular hearing loss with the most prescriptive amplification needed. Complete flexibility and enhanced fine-tuning capability are among the many benefits. This unique technology separates the incoming sound into bands and channels; and then processes each band and channel independently. This class of hearing instruments utilizes separate circuit paths to independently process different frequency regions of sound. A DSP hearing aid converts the signal which was received at the microphone into a digital format before processing it, and in most digital aids, converts it back to analog before sending the signal to the speaker.

DSP hearing aids (like most others) are quite expensive, typically costing several thousands of dollars. While the average life span may reach 5 years or more, this does not mean the hearing aid will maintain a high level of performance over these years. It is important that the hearing aid be routinely cleaned and protected against entry of moisture, dust, and other foreign matter. Some hearing aids are well sealed, while others require more care and are more prone to damage—particularly, BTE hearing aids. There is no standard manufacturing protocol which ensures an effectively sealed hearing aid. For standard BTE hearing aids, the instrument case is typically molded in several parts and assembled using an adhesive or other suitable means. The attached parts create seams which define intrusion points for moisture and other harmful foreign matter.

Several commercially available products, such as hearing aid condoms, offer means for temporarily sealing the instrument case of a BTE hearing aid. Hearing aid condoms are thin cloth or latex sheaths which are placed over and substantially encapsulate the hearing aid. The condoms protect the hearing aid from perspiration, dirt, grime, hair spray, bathroom humidity, fluctuating heat and cold such as in a factory, changing atmosphere, and air-borne pollen, dust, and other organic matter. Such condoms, however, have numerous drawbacks and limitations. For example, any moisture entering the instrument case will often become trapped by the condom creating an increased likelihood of damage. Another disadvantage is that the hearing aid will squeal if the condom covers the microphone port. Additionally, the condoms (particularly latex ones) can be difficult to install as the hearing aid tends to stick to the side of the condom as it is being inserted.

### SUMMARY OF THE INVENTION

Therefore, it is an object of the invention to provide a BTE hearing aid with a substantially seamless, integrally-molded instrument case.

It is another object of the invention to provide a BTE hearing aid which substantially limits intrusion of moisture, dust, and other foreign matter into the electronics compartment of the instrument case.

It is another object of the invention to provide a BTE hearing aid which has a sleek, ergonomic shape.

It is another object of the invention to provide a BTE hearing aid which maintains a high sound quality through an extended period of usage.

It is another object of the invention to provide a BTE hearing aid which limits the need for drying kits which could be harmful to Zinc-air batteries.

It is another object of the invention to provide a BTE hearing aid which enable convenient access to internal parts and hardware.

It is another object of the invention to provide a BTE hearing aid which has a modular internal parts assembly which is readily replaceable, exchangeable, and accessible.

These and other objects of the present invention are achieved in the preferred embodiments disclosed below by providing a behind-the-ear hearing aid including an arcuate, integrally-molded instrument case adapted for residing behind an ear of a wearer. The instrument case defines a substantially seamless electronics compartment containing a microphone and a loudspeaker operatively connected to the microphone. An amplifier serves to boost a sound signal transmitted from the microphone through the loudspeaker to the ear of the wearer.

The term “seam” refers to any circular, curved or straight line across a surface of the instrument case, and defining a point of entry for moisture, dust, and/or other foreign matter into the electronics compartment. The term “substantially seamless” means that the sum total of all seams across the surface of the instrument case is less than 80 mm.

According to another preferred embodiment of the invention, a battery is located in the electronics compartment and is operatively connected to the various instrument components for powering the hearing aid.

Preferably, the battery is a Zinc-air battery.

According to another preferred embodiment of the invention, the instrument case defines an access opening for allowing convenient access to the electronics compartment.

According to another preferred embodiment of the invention, a pivoted access door is located at the access opening, and is movable between open and closed positions.

According to another preferred embodiment of the invention, an arcuate battery arm depends from the access door for holding the battery inside the electronics compartment.

According to another preferred embodiment of the invention, a detachable mounting frame is located at the access opening. Preferably, the mounting frame surrounds the access door with the door in the closed position.

According to another preferred embodiment of the invention, opposing spaced-apart battery springs depend from the mounting frame, and are located to engage respective battery contacts.

According to another preferred embodiment of the invention, a programmable computer chip is located in the electronics compartment. The computer chip is adapted for digitally processing the sound signal received at the microphone prior to sending the signal to the loudspeaker.

According to another preferred embodiment of the invention, the battery springs, microphone, and computer chip are attached to the mounting frame, and are removable from the instrument case as a single module.

According to another preferred embodiment of the invention, a volume control wheel serves to adjust the sound signal emanating from the loudspeaker.

According to another preferred embodiment of the invention, a memory button is provided for changing between listening programs programmed into the hearing aid.

Preferably, the hearing aid includes a flexible sound-transfer tube having a proximal end attached to the instrument case and a free end adapted for inserting in the ear of the wearer.

### BRIEF DESCRIPTION OF THE DRAWINGS

Some of the objects of the invention have been set forth above. Other objects and advantages of the invention will appear as the description proceeds when taken in conjunction with the following drawings, in which:

FIG. 1 is an environmental perspective view of the BTE hearing aid according to one preferred embodiment of the present invention;

FIG. 2 is a side view of the BTE hearing aid;

FIG. 3 is an enlarged longitudinal cross-section of the instrument case and showing various internal parts of the hearing aid;

FIG. 4 is an enlarged lateral cross-section of the instrument case with various internal parts of the hearing aid shown;

FIG. 5 is an enlarged side view of instrument case with the access door in the open position; and

FIG. 6 is a further side view of the BTE hearing aid with the modular internal parts assembly removed from the instrument case, and the battery removed from the battery arm.

### DESCRIPTION OF THE PREFERRED EMBODIMENT AND BEST MODE

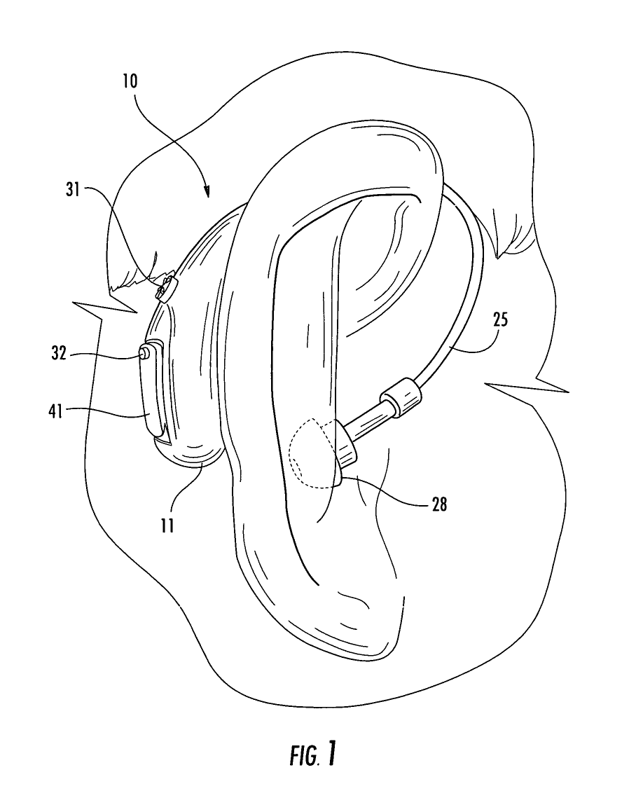

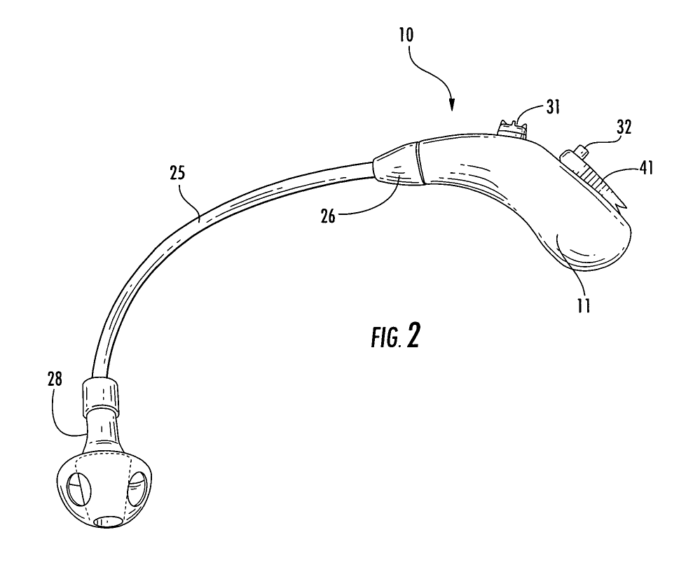

Referring now specifically to the drawings, a BTE hearing aid according to the present invention is illustrated in FIGS. 1 and 2, and shown generally at reference numeral 10. The hearing aid 10 comprises a sleek, ergonomic, integrally-molded instrument case 11 which is designed to reside behind an ear of the wearer.

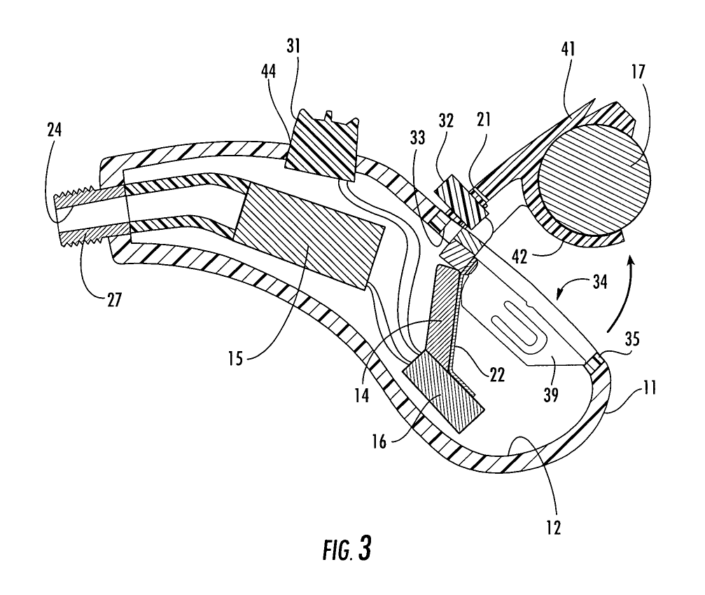

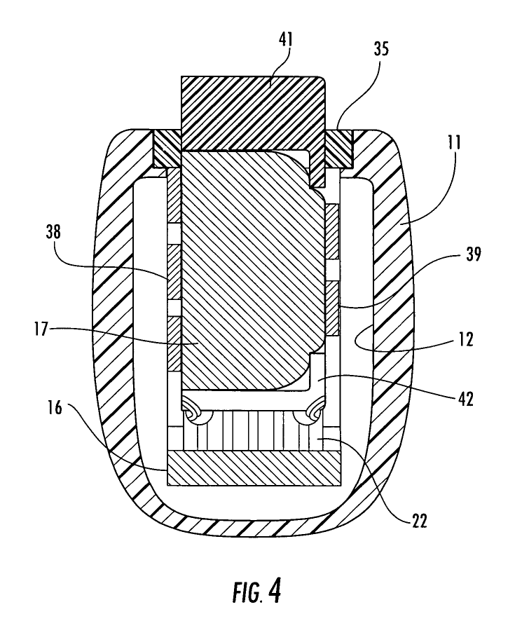

As best shown in FIGS. 3 and 4, the instrument case 11 forms a substantially seamless electronics compartment 12. Conventional components including a microphone 14, loudspeaker 15, computer chip 16 and battery 17 are all housed in the electronics compartment 12. By inserting a programming strip (not shown) through slot 21 in the instrument case 11, the computer chip 16 is programmed to match a particular hearing loss with the most prescriptive amplification needed. The programming strip contacts a flex PCB interface 22.

Using known DSP technology, the hearing aid 10 converts a sound signal received at the microphone 14 into a digital format before processing it, and then converts it back to analog before sending the signal to the loudspeaker 15. From the loudspeaker 15, the sound signal exits the instrument case 11 through sound port 24, and is transmitted through a flexible sound tube 25 to the ear of the wearer. The sound tube 25 has an internally-threaded fitting 26 at its proximal end which mates with a complementary-threaded connector 27 attached to the instrument case 11. A replaceable and exchangeable ear tip 28 is located at the free end of the sound tube 25.

Preferably, the hearing aid 10 further includes a standard volume control wheel 31 and memory button 32. The volume control wheel 31 enables convenient manual adjustment of tone (low and high frequencies) and volume so that the wearer can hear enhanced sounds within a comfortable tolerance level. The memory button 32 allows the wearer to change between various pre-programmed listening programs.

The instrument case 11 is preferably manufactured in a single-cavity mold. Generally described, the mold is first heated in water, and air blown through it to clear away any impurities. A technician then mixes liquid acrylic of equal parts monomer and polymer, and adds the desired pigment to give the case a pink, tan, or brown color. The technician pours the liquid into the heated mold, and then pours off any excess, leaving a thin acrylic shell inside the mold. The resulting instrument case 11 has a small microphone port 33 and an access opening 34 (FIG. 3) to the electronics compartment 12.

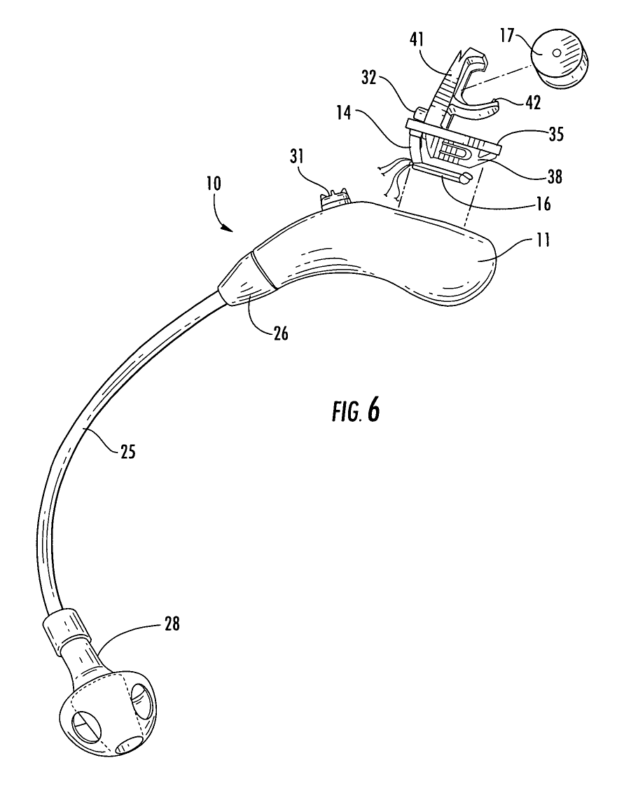

Referring to FIGS. 3, 4, and 6, a detachable mounting frame 35 is located at a mouth of the access opening 34, and serves to carry (in a single module) various internal components of the hearing aid including the microphone 14, computer chip 16, and opposing battery springs 38 and 39. This convenient modular assembly of hardware allows the case 11 to be manufactured as a small integrally-formed unit without employing a standard face plate for mounting the hardware. The present construction thereby facilitates access to internal parts, and assembly and replacement of parts. The mounting frame 35 is preferably held in place at the access opening 34 using a light contact adhesive or other suitable means.

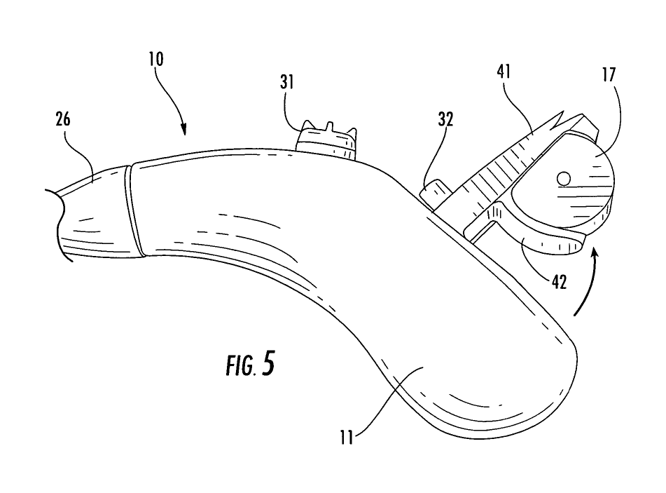

According to one embodiment, the mounting frame 35 is manufactured using stereolithography and selective laser sintering systems known in the art. The access opening 34 is selectively opened and closed via a pivoted access door 41. The access door 41 has an arcuate battery arm 42, best shown in FIGS. 3, 5, and 6, designed for holding the battery 17 such that when the door 41 is closed, the battery 17 engages the springs 38, 39 at respective positive and negative contacts. Preferably, the battery 17 is a small Zinc-air battery commonly used in other prior art hearing aids.

Because of its substantially seamless design, the instrument case 11 limits entry of harmful moisture and/or foreign matter into the electronics compartment 12. The total seam length across the instrument case 11 at the access opening 34 and mounting frame 35, and around a circular opening 44 for the volume control wheel 31 is preferably less than 50 mm, and more preferably less than 40 mm, and most preferably between 25-40 mm.

A BTE hearing aid is described above. Various details of the invention may be changed without departing from its scope. Furthermore, the foregoing description of the preferred embodiment of the invention and best mode for practicing the invention are provided for the purpose of illustration only and not for the purpose of limitation—the invention being defined by the claims.

I claim:

1. A behind-the-ear hearing aid, comprising:
an arcuate, integrally-molded instrument case adapted for residing behind an ear of a wearer;
said instrument case defining a substantially seamless electronics compartment;
a microphone contained in said electronics compartment;
a loudspeaker contained in said electronics compartment, and operatively connected to said microphone; and
means for amplifying a sound signal transmitted from said microphone through said loudspeaker to the ear of the wearer.

2. A behind-the-ear hearing aid according to claim 1, and comprising a battery located in said electronics compartment and adapted for powering said hearing aid.

3. A behind-the-ear hearing aid according to claim 2, wherein said instrument case defines an access opening for accessing said electronics compartment.

4. A behind-the-ear hearing aid according to claim 3, and comprising a pivoted access door located at said access opening and adapted for moving between open and closed positions.

5. A behind-the-ear hearing aid according to claim 4, and comprising an arcuate battery arm depending from said access door and designed for holding said battery.

6. A behind-the-ear hearing aid according to claim 5, and comprising a detachable mounting frame located at said access opening, and surrounding said access door when in the closed position.

7. A behind-the-ear hearing aid according to claim 6, and comprising opposing spaced-apart battery springs depending from said mounting frame and adapted for engaging respective battery contacts.

8. A behind-the-ear hearing aid according to claim 7, and comprising a programmable computer chip located in said electronics compartment and adapted for digitally processing the sound signal received at said microphone prior to sending the signal to said loudspeaker.

9. A behind-the-ear hearing aid according to claim 8, wherein said battery springs, microphone, and computer chip are attached to said mounting frame, and are removable from said instrument case as a single module.

10. A behind-the-ear hearing aid according to claim 1, and comprising a volume control wheel adapted for adjusting the sound signal emanating from said loudspeaker.

11. A behind-the-ear hearing aid according to claim 1, and comprising a memory button adapted for changing between listening programs programmed into said hearing aid.

12. A behind-the-ear hearing aid according to claim 1, and comprising a flexible sound-transfer tube having a proximal end attached to said instrument case and a free end adapted for inserting in the ear of the wearer.

13. A behind-the-ear hearing aid, comprising:
an arcuate, integrally-molded instrument case adapted for residing behind an ear of a wearer;
said instrument case defining a substantially seamless electronics compartment, and an access opening for accessing said electronics compartment;
a pivoted access door located at said access opening and adapted for moving between open and closed positions;
a detachable mounting frame located at said access opening, and surrounding said access door when in the closed position;
a microphone contained in said electronics compartment;
a loudspeaker contained in said electronics compartment, and operatively connected to said microphone;
a programmable computer chip located in said electronics compartment and adapted for digitally processing a sound signal received at said microphone prior to sending the signal to said loudspeaker; and
wherein at least said microphone and computer chip are attached to said detachable mounting frame, and are removable from said instrument case as a single module.

14. A behind-the-ear hearing aid according to claim 13, and comprising a battery located in said electronics compartment and adapted for powering said hearing aid.

15. A behind-the-ear hearing aid according to claim 14, and comprising an arcuate battery arm depending from said access door and designed for holding said battery.

16. A behind-the-ear hearing aid according to claim 15, and comprising opposing spaced-apart battery springs depending from said mounting frame and adapted for engaging respective battery contacts.

17. A behind-the-ear hearing aid according to claim 13, and comprising a volume control wheel adapted for adjusting the sound signal emanating from said loudspeaker.

18. A behind-the-ear hearing aid according to claim 13, and comprising a memory button adapted for changing between listening programs programmed into said hearing aid.

19. A behind-the-ear hearing aid according to claim 13, and comprising a flexible sound-transfer tube having a proximal end attached to said instrument case and a free end adapted for inserting in the ear of the wearer.

20. A behind-the-ear hearing aid according to claim 14, wherein said battery comprises a Zinc-air battery.
